(19) United States
(12) Patent Application Publication
(10) Pub. No.: US 2007/0277928 A1
(43) Pub. Date: Dec. 6, 2007

(54) Adhesive system

(75) Inventor: Farideh Khabbaz, Bromma (SE)

Correspondence Address: AKZO NOBEL INC., INTELLECTUAL PROPERTY DEPARTMENT, 120 WHITE PLAINS ROAD 3RD FLOOR, TARRTOWN, NY, 10591, US

(73) Assignee: AKZO NOBEL COATINGS INTERNATIONAL B.V., Arnhem (NL)

(21) Appl. No.: 11/807,092

(22) Filed: May 25, 2007

Related U.S. Application Data
(60) Provisional application No. 60/810,676, filed on Jun. 1, 2006.

(51) Int. Cl. C09J 189/00

(52) U.S. Cl. 156/328; 524/17

(57) ABSTRACT

The invention relates to an adhesive system comprising a protein and one or more polymers containing acetoacetoxy groups. It also relates to a method of producing a laminated wood based product and a particle board.

The present invention relates to an adhesive system and a method of producing a wood based product.

### INTRODUCTION

Formaldehyde based resins such as phenol-formaldehyde resin, melamine-formaldehyde resin and urea-formaldehyde resin are widely used as binders in the production of wood based products. Examples of such wood based products are composite products comprising layers glued together such as plywood, laminated flooring products and veneered products used in, e.g., furniture. Further examples are board products such as particle-, chip- and fibreboards wherein wood chips and/or fibres, together with a binder, are pressed to form a board.

Upon curing a formaldehyde based resin, formaldehyde may be released both during the manufacture of the wood based product and also later during use of the product. Formaldehyde emission to indoor air is a major concern since many years for health reasons.

There is an increasing demand for formaldehyde-free wood adhesives which give sufficient bond strength and overall end-product quality making them suitable as alternatives to prior art adhesives containing formaldehyde based resins.

Water resistance and bond strength are generally important properties reflecting quality for the wood based products. Generally there exist specific quality parameters required for meeting an established standard for a specific end-product. For example, a particle board needs to meet certain standards in terms of, e.g., internal bonding, thickness swelling and water absorption, while a laminated flooring product needs to meet certain standards in terms of, e.g., delamination.

Protein based adhesives were used in the production of plywood many decades ago but were replaced by formaldehyde based resins due to their superior performance. Recently, there have been proposed different types of protein-based adhesives. WO 2005/113700 A1, US 2004/0037906 and US 2004/0089418 disclose adhesive compositions based on soy protein. A further example of a protein based adhesive is disclosed in Li et al., “Soy-based adhesives with 1,3-dichloro-2-propanol as a curing agent”, Wood and Fiber Science, 36(2), 2004, pp. 186-194. US 2002/0005251 discloses an adhesive based on soy protein isolate. US 2005/0166796 discloses an adhesive composition comprising soy protein isolate. U.S. Pat. No. 6,790,271 and US 2005/0234156 disclose adhesive compositions comprising soy protein isolate used for forming a particle board. Mori et al., “A honeymoon-type adhesive for wood products . . . ”, J. of applied polymer science, Vol. 91, 2966-2972 (2004) discloses acetoacetylated polyvinyl alcohol in wood adhesives but not in combination with any protein. U.S. Pat. No. 4,350,788, U.S. Pat. No. 4,687,809 and US 2005/0197441 A1 disclose the use of acetoacetylated polyvinyl alcohol in wood adhesives but not in combination with any protein.

There is still a need for an alternative protein based wood adhesive which gives high bond strength and high product quality.

Accordingly, the present invention provides a protein based adhesive composition which gives excellent gluing strength and product quality in terms of, e.g. water resistance. Also, a method of producing wood based products is provided.

### THE INVENTION

The present invention provides an adhesive system comprising a protein and one or more polymers (P) containing acetoacetoxy groups.

By “adhesive system” is herein meant a combination of two or more components which forms, and functions as, a wood adhesive. In the term “adhesive” is herein also included the term “binder”.

The present invention also relates to a method of producing a wood based product comprising providing an adhesive system, comprising a protein one or more polymers (P) containing acetoacetoxy groups onto one or more pieces of a wood-based material and joining the pieces with one or more further pieces of a material, preferably wood based material.

The weight ratio protein to one or more polymers (P) is suitably from about 1:2 to about 100:1, preferably from about 1:1 to about 100:1, more preferably from about 1:1 to about 20:1, most preferably from about 2:1 to about 10:1.

In one embodiment the adhesive system comprises an adhesive composition.

The adhesive composition suitably comprises from about 1 to about 99 weight % of protein, preferably from about 3 to about 75 weight %, most preferably from about 5 to about 50 weight %.

The adhesive composition suitably comprises from about 0.1 to about 99 weight % of the one or more polymers (P), preferably from about 1 to about 80 weight %, more preferably 2 to about 50 weight %, even more preferably from about 2 to about 25 weight %, most preferably from about 5 to about 15 weight %.

The solids content in the adhesive composition is suitably from about 10 to about 95 weight %, preferably from about 20 to about 75 weight %, most preferably from about 30 to about 50 weight %.

In one embodiment the adhesive system comprises the protein and the one or more polymers (P) as separate components which preferably remain separated until their actual use in the gluing process. The separate components of the adhesive system may also be mixed a short time before the actual use in the gluing process, thereby forming an adhesive composition of the present invention. By “short time” is herein suitably meant less than about 1 hour, preferably less than about 30 minutes, most preferably less than about 15 minutes.

In one embodiment of the method of the invention, the adhesive system is applied onto one or more pieces of a wood-based material as separate components, wherein one component comprises the protein and a further component comprises the one or more polymers (P).

The component comprising protein may comprise a protein solution or dispersion, or comprise the protein as a dry material. The protein solution or dispersion is preferably aqueous. The component comprising the one or more polymers (P) is suitably a solution or dispersion, preferably an aqueous solution or dispersion, or as a solid material. As a separate component of the adhesive system, the polymer (P) is suitably present in an aqueous composition comprising from about 0.1 to about 99 weight % of polymer (P), preferably from about 1 to about 80 weight %, more preferably from about 2 to about 50 weight %, even more preferably from about 2 to about 25 weight %, most preferably from about 3 to about 15 weight %.

When provided as separate components of the adhesive system onto the one or more pieces of wood-based material, there is preferably a sequential application of components of the adhesive system comprising a first component applied and a second component applied.

In one embodiment of the method of the invention, the first component applied comprises a protein, either as a solution or dispersion, or as a dry material, and the second component applied comprises a solution or dispersion of the one or more polymers (P).

In one embodiment of the method of the invention, the first component applied comprises a solution or dispersion of the one or more polymers (P) and the second component applied comprises a protein, either as a solution or dispersion, or as a dry material.

In one embodiment of the method of the invention, the first component applied comprises the one or more polymers (P) as a solid material and the second component applied comprises a protein, either as a solution or dispersion, or as a dry material.

In one embodiment of the method of the invention, a mixture of the one or more polymers (P) as a solid material and a protein as a dry material is applied.

In one embodiment of the method of the invention, the first applied component being a solution or dispersion is dried after application before the second component is applied. In this case, the first applied component is preferably a solution or dispersion of the one or more polymers (P).

Examples of suitable proteins are native proteins, i.e. unmodified proteins, and modified proteins, originating from, e.g., milk (casein), soy, potato, corn, wheat, rice, peas etc. Examples of suitable soy protein products include soy protein concentrate, soy meal, soy protein hydrolysate and soy protein isolate. Preferably, the protein is a soy protein isolate (SPI). The protein is suitably provided for use in the present invention in the form of a product such as a protein meal or a protein isolate. The protein content in the protein meal or protein isolate is suitably from about 30 to about 100 weight %, preferably from about 50 to about 100 weight %, most preferably from about 70 to about 100 weight %.

An aqueous composition comprising 12 weight % of the protein has suitably a viscosity (Brookfield, 12 rpm, spindle 4, at 20° C.) of from about 500 to about 5.000.000 mpa*s, preferably from about 1.000 to about 2.000.000 mPa*s, more preferably from about 50.000 to about 1.500.000 mPa*s. most preferably from about 100.000 to about 1.000.000 mPa*s.

The one or more polymers (P) have suitably a weight average molecular weight of from about 1.000 to about 5.000.000 g/mol, preferably from about 10.000 to about 2000.000 g/mol.

The content of acetoacetoxy groups in the one or more polymers (P) is suitably from about 0.05 to about 50 mole %, preferably from about 1 to about 30 mole %, most preferably from about 5 to about 20 mole %.

The one or more polymers (P) preferably comprises acetoacetylated polyvinyl alcohol (AAPVA).

The adhesive system suitably further comprises one or more polymers (P1) containing amine or amide groups, preferably as a separate component or as mixed with the protein component. The amide groups are preferably pendant amide groups.

By the term “amide groups” is herein included formamide groups.

The one or more polymers (P1) preferably comprise primary amine groups or formamide groups. Preferably the one or more polymers (P1) comprises polyvinylamine, polyvinylformamide, poly(vinylalcohol-co-vinylamine), poly(vinylalcohol-co-vinylformamide), polyallyl amine, polyethylene imine or polyamidoamine. Most preferably the one or more polymers (P1) comprises polyvinylamine or polyethylene imine.

The one or more polymers (P1) suitably have a weight average molecular weight of from about 1.000 to about 5.000.000 g/mol, preferably from about 10.000 to about 2000.000 g/mol.

As a separate component of the adhesive system, the polymer (P1) is suitably present in an aqueous composition comprising from about 0.1 to about 99 weight % of polymer (P1), preferably from about 1 to about 80 weight, more preferably from about 2 to about 50 weight %, even more preferably from about 2 to about 25 weight %, most preferably from about 3 to about 15 weight %.

The aqueous composition comprising the one or more polymers (P1) may further comprise inorganic- or organic salts. A part of the one or more polymers (P1) may be ionically charged, preferably cationically charged. The amount of negative counter-ions of the salts in the aqueous composition is suitably from 0 to about 50 weight %, preferably from about 1 to about 30 weight %, most preferably from about 2 to about 20 weight %.

The one or more components of the adhesive system comprising protein, polymer (P) and optionally polymer (P1) respectively, or the adhesive composition comprising protein and polymer, and optionally polymer (P1), may further comprise additives and fillers such as kaolin.

In one embodiment of the method the adhesive composition is dried after application and later activated by adding water or an aqueous composition comprising the one or more polymers (P) or an aqueous composition comprising one or more polymers (P1).

In one embodiment the adhesive system comprises the protein, the one or more polymers (P) and the one or more polymers (P1) as separate components which remain separated until their actual use in the gluing process. The separate components of the adhesive system may also be mixed a short time before the actual use in the gluing process, thereby forming an adhesive composition of the present invention. By “short time” is herein suitably meant less than about 1 hour, preferably less than about 30 minutes, most preferably less than about 15 minutes.

In one embodiment of the method of the invention, the adhesive system is applied onto one or more pieces of a wood-based material as separate components, wherein one component comprises the protein, a further component comprises the one or more polymers (P), and a further component comprises the one or more polymers (P1). The component comprising protein may comprise a protein solution or dispersion, or comprise the protein as a dry material. The component comprising the one or more polymers (P) is suitably a solution or dispersion. The component comprising the one or more polymers (P1) is suitably a solution or dispersion.

In one embodiment of the method a first component applied comprises a solution or dispersion of the protein and the one or more polymers (P), which is dried before application of a second component which comprises a solution or dispersion of the one or more polymers (P1).

In one embodiment of the method a first component applied comprises a solution or dispersion of the protein and the one or more polymers (P1), which is dried before application of a second component which comprises a solution or dispersion of the one or more polymers (P).

In one embodiment of the method a first component applied comprises a solution or dispersion of the one or more polymers (P), which is dried before application of a second component which comprises a solution or dispersion of the protein and the one or more polymers (P1).

In one embodiment of the method a first component applied comprises a solution or dispersion of the one or more polymers (P1), which is dried before application of a second component which comprises a solution or dispersion of the protein and the one or more polymers (P).

The amount of protein and one or more polymers (P) and the optional one or more polymers (P1) in the adhesive composition suitably make up at least 75 weight % of components having a molecular weight equal to or above 1000 g/mole, also suitably from about 75 to about 100 weight %, preferably at least 85 weight %, also preferably from about 85 to about 100 weight %, most preferably at least 95 weight %, also most preferably from about 95 to about 100 weight %.

The invention further relates to the use of the adhesive system according to the invention for gluing pieces of wood based materials forming a wood based product.

In one embodiment of the present invention, the pieces of wood based material are sheets or lamellas. In this case, the wood based product is suitably a laminated flooring material, veneered flooring, a veneered furniture material, plywood, a wall panel, a roofing panel or a laminated beam.

In one embodiment of the present invention, the pieces of wood based material are wood chips or wood particles, such as chips, shavings, flakes, sawdust or any similar finely divided wood based material. In this case the wood based product is suitably a chip-, particle-, or fibreboard, or oriented strand board.

The moisture content of the wood particles to be used in the present invention is suitably from about 0 to about 20 weight %, preferably from about 1 to about 10 weight %, more preferably from about 1.5 to about 5 weight %.

The weight ratio wood particles to adhesive system, calculated as dry weight, is suitably from about 100:1 to about 1:1, preferably from about 50:1 to about 2:1, more preferably from about 30:1 to about 2.5:1, most preferably from about 15:1 to about 3:1.

The method according to the invention suitably comprises the steps of contacting one or more pieces of wood based material with the adhesive system according to the invention, pressing and thereby joining pieces of wood based material with further wood based material. The pressing suitably takes place at an elevated temperature. The wood based material can be any type and form of wood based material such as chips, fibres, sheets, laminas, veneers, pieces etc. The method suitably comprises application of the adhesive composition according to the invention onto a surface of the wood based material followed by pressing. The pressing temperature depends on which wood based product intended to be manufactured but is suitably from about 50 to about 250° C. and preferably from about 70 to about 200° C. For particle-, chip-, and fibreboard products, the pressing temperature is preferably from about 100 to about 225° C., most preferably from about 150 to about 200° C. For laminated products, such as plywood, laminated flooring or veneered flooring products, the pressing temperature is preferably from about 70 to about 175° C., most preferably from about 90 to about 160° C.

The pressing time and pressing temperature are linked so that lower pressing temperatures generally require longer pressing times. The wood based product to be produced does also determine suitable pressing temperatures and pressing times. The pressing time is suitably at least about 10 s , also suitably from about 10 s to about 60 minutes, preferably at least about 30 s, also preferably from about 30 s to about 30 minutes, most preferably at least about 1 minute, also preferably from about 1 to about 15 minutes.

In one embodiment of the method, when manufacturing laminated products, the method suitably comprises application of the adhesive composition according to the invention onto a surface so that the glue joint will comprise an originally applied amount of from about 0.1 to about 500 g/m². The applied amount depends on the product to be produced: for compression moulded veneers it is preferably from about 50 to about 200 g/m², for laminated flooring material it is preferably from about 100 to about 160 g/m². The suitable upper limit also depends on which type of wood based material that is applied with the solution. The adhesive composition may be applied on one or both of the surfaces to be joined. If applied on both surfaces, the sum of the amounts applied on each surface will correspond to the preferred amounts for the whole glue joint specified.

In another embodiment of the method, when manufacturing laminated products, the method suitably comprises application of the adhesive system according to the invention as separate components of the protein and the one or more polymers (P) onto a surface. Suitably, both the protein and polymer (P) are applied as aqueous compositions. Alternatively, the protein and the one or more polymers (P) can be applied onto separate surfaces intended to be joined. The total amount of applied adhesive system onto the one or both surfaces is such that the glue joint will comprise an originally applied amount of from about 0.1 to about 500 g/m². The applied amount depends on the product to be produced: for compression moulded veneers it is preferably from about 50 to about 200 g/m², for laminated flooring material it is preferably from about 100 to about 160 g/m². The suitable upper limit also depends on which type of wood based material that is applied with the solution.

In another embodiment of the method, when manufacturing particle-, chip-, or fibre boards and similar products, the method suitably comprises application of the adhesive system according to the invention as separate components of the protein and the one or more polymers (P) onto the wood chips.

When applied separately, in the manufacturing of particle-, chip-, or fibre boards and similar products, the protein can be applied in dry form or as present in an aqueous composition. Preferably, the protein is applied in dry form. The one or more polymers (P) can be applied as a solid or as an aqueous composition. The one or more polymers (P) are preferably first added to the chips followed by addition of the protein.

In one embodiment, in the manufacturing of particle-, chip-, or fibre boards and similar products, the one or more polymers (P) are applied as an aqueous composition followed by the addition of protein in dry form.

In one embodiment, in the manufacturing of particle-, chip-, or fibre boards and similar products, the one or more polymers (P) are applied as a solid simultaneously with the protein in dry form.

The present invention also relates to a wood based product obtainable by the method of producing a wood based product.

The wood based product is suitably a particle-, chip-, or fibreboard product. Alternatively, the wood based product is suitably a laminated products, such as plywood, laminated flooring or veneered flooring product.

A particle-, chip-, or fibreboard product made according to the invention suitably has a content of protein from about 1 to about 20 weight %, preferably from about 3 to about 15 weight %, calculated as dry weight.

A particle-, chip-, or fibreboard product made according to the invention suitably has a content of the polymer comprising acetoacetoxy groups of from about 0.5 to about 10 weight %, preferably from about 1 to about 5 weight %, calculated as dry weight.

The invention is further illustrated by means of the following non-limiting examples. Parts and percentages relate to parts by weight respectively percent by weight, unless otherwise stated.

### EXAMPLES

### Example 1

Veneered products were made by applying different compositions onto a 15×15 cm different particle boards followed by drying for 5 days. The dried adhesive layers were then remoistened followed by veneering a layer of 0.6 mm beech onto the boards. The assemblies were pressed during 1 minute at 130° C. The fiber tear (chisel) was tested.

The compositions tested were:
1) 14 g soy protein isolate (SPI) (Supro®500E from Solae), 100 ml water.
2) 8 g soy protein isolate (SPI) (Supro®500E from Solae), 50 g acetoacetylated polyvinyl alcohol solution (AAPVA) (Gohsefimer® Z-220 from Nippon Gohsei) (5 wt %),
3) 8 g soy protein isolate (SPI) (Supro®500E from Solae), 50 g acetoacetylated polyvinyl alcohol solution (AAPVA) (Gohsefimer® Z-220 from Nippon Gohsei) (10 wt %).

TABLE 1

| First applied | Amount | | Fiber tear (%) | |
|---|---|---|---|---|
| component | first applied | Remoistening | Warm | Cold |
| SPI | 2.7 g | 1 g water | 20–30 | ~5 |
| SPI | 2.7 g | 1 g AAPVA | 50–60 | 50–60 |
| | | (12 wt %) | | |
| SPI + AAPVA | 3.7 g | 1.4 g water | ~90 | ~30 |
| (5 wt %) | | | | |
| SPI + AAPVA | 3.7 g | 1.4 g water | 100 | 100 |
| (10 wt %) | | | | |
| SPI + AAPVA | 3.7 g | 1.1 g | 100 | 100 |
| (10 wt %) | | polyvinylamine | | |
| | | (11 wt %) | | |

### Example 2

A particle board was manufactured by mixing 864 g wood chips, having a moisture content of 2 weight %, with 205 g of an aqueous solution of about 11 weight % acetoacetylated polyvinyl alcohol (AAPVA) (Gohsefimer® Z-220 from Nippon Gohsei), followed by mixing in about 85 g of a soy protein isolate (SPI) (Prisolate® 601 EM from Food Partner). The SPI had a protein content of >90 weight % and a dry content of 94 weight %. The chips mixture was formed into a sheet of 30×30 cm and pressed at 185° C. for three minutes and pressed into a board of 16 mm thickness. The sequence of pressure was 160 kg/cm² during 30 s, 40 kg/cm² during 2.5 min and no pressure during the last 30 s. The tensile strength (internal bond, IB), thickness swelling (TSW) and water absorption (ABS) were measured.

A further particle board was manufactured in the same way as previously by mixing 994 g wood chips, having a moisture content of 2 weight %, with about 85 g of a soy protein isolate (Supro® 500E from Solae). The SPI had a protein content of >90 weight % and a dry content of 94 weight %. The tensile strength (internal bond, IB) was measured.

TABLE 2

| | | | | Moisture | | | |
|---|---|---|---|---|---|---|---|
| | | | | content | | | |
| Wood | | | | before | | TSW | ABS |
| chips | | Protein | AAPVA | pressing | IB | 24 h | 24 h |
| (g) | Protein | (g) | (11%), (g) | (%) | (kPa) | (%) | (%) |
| 864 | SPI | 85.3 | 205 | 14.6 | 490 | 30.2 | 93.7 |
| 994 | SPI | 79.6 | — | 7.8 | 10 | —* | —* |

*not measured

### Example 3

Particle boards were manufactured in a smaller scale by mixing 50.7 g wood chips respectively, having a moisture content of 2 weight %, with 1 g of acetoacetylated polyvinyl alcohol (AAPVA) (Gohsefimer® Z-220 from Nippon Gohsei), present as an aqueous solution of about 16.5 weight %, followed by mixing in soy protein isolate (SPI) (Supro® 500E from Solae) in various amounts. The SPI had a protein content of >90 weight % and a dry content of 94 weight %. A reference with no SPI and a reference with no AAPVA was also prepared. The chips mixtures were pressed into boards of 10 mm thickness. The pressing was made at 9 kg/cm² at 180-185° C. during 5 minutes. The internal bond strength (IB) was measured by gluing pieces of 5×5 cm onto two metal blocks and tearing them apart.

TABLE 3

| Amount protein | | |
|---|---|---|
| (SPI) | Amount AAPVA | IB |
| (g) | (g) | (kPa) |
| — | 1 | 127 |
| 0.2 | 1 | 222 |
| 0.5 | 1 | 359 |
| 2 | 1 | 480 |
| 5 | 1 | 322 |
| 5 | — | 176 |

1. Adhesive system comprising a protein and one or more polymers (P) containing acetoacetoxy groups.

2. Adhesive system according to claim 1, wherein the weight ratio protein to one or more polymers (P) is from about 1:2 to about 100:1.

3. Adhesive system according claim 1, wherein the weight ratio protein to one or more polymers (P) is from about 1:1 to about 20:1.

4. Adhesive system according to claim 1, which comprises an adhesive composition.

5. Adhesive system according to claim 4, wherein the adhesive composition comprises from about 5 to about 30 weight % of the protein.

6. Adhesive system according to claim 4, wherein the adhesive composition comprises from about 3 to about 15 weight % of the one or more polymers (P).

7. Adhesive system according to claim 1, comprising the protein and the one or more polymers (P) as separate components.

8. Adhesive system according to claim 1, wherein the one or more polymers (P) comprise acetoacetylated polyvinylalcohol.

9. Adhesive system according to claim 1, comprising one or more polymers (P1) containing amino groups or amide groups.

10. Adhesive system according to claim 1, wherein the one or more polymers (P1) comprise polyvinylamine.

11. Method of producing a wood based product comprising providing an adhesive system comprising a protein and one or more polymers (P) containing acetoacetoxy groups onto one or more pieces of a wood based material and joining the pieces with one or more further pieces of a material.

12. Method according to claim 11, wherein the adhesive system is provided onto pieces of a wood-based material as an adhesive composition.

13. Method according to claim 12, wherein the adhesive composition is dried after application and later activated by adding water or an aqueous composition comprising the one or more polymers (P) or an aqueous composition comprising one or more polymers (P1) containing amino groups or amide groups.

14. Method according to claim 11, wherein the adhesive system is provided onto pieces of a wood-based material as separate components, wherein one component comprises the protein and another component comprises the one or more polymers (P).

15. Method according to claim 14, wherein the first component applied comprises a protein solution or dispersion and the second component applied comprises a solution or dispersion of the one or more polymers (P).

16. Method according to claim 14, wherein the first component applied comprises a solution or dispersion of the one or more polymers (P) and the second component comprises the protein, either as a solution or dispersion or as a dry material.

17. Method according to claim 15, wherein the first component applied is dried after application before the second component is applied.

18. Method according to claim 11, wherein the adhesive system comprises one or more polymers (P1) containing amino groups or amide groups as a separate component.

19. Method according to claim 13, wherein the one or more polymers (P1) comprise polyvinylamine.

20. Method according to claim 18, wherein the one or more polymers (P1) comprise polyvinylamine.

21. Method according to claim 11, wherein the pieces are one or more of sheets, lamellas and veneers.

22. Method according to claim 21, wherein the wood based product is a laminated flooring material, veneered flooring, a veneered furniture material, plywood, a wall panel, a roofing panel or a laminated beam.

23. Method according to claim 11, wherein the pieces are wood chips or wood particles.

24. Method according to claim 23, wherein the wood based product is a chip-, particle- or fibre board, or an oriented strand board.

25. Wood based product obtained by the method according to claim 11.
